(19) United States
(12) Patent Application Publication
(10) Pub. No.: US 2013/0244525 A1
(43) Pub. Date: Sep. 19, 2013

(54) BLENDED INSULATION BLANKET

(71) Applicant: OWENS CORNING INTELLECTUAL CAPITAL, LLC, Toledo, OH (US)

(72) Inventors: Jacob T. Chacko, Pickerington, OH (US); Jeffrey A. Tilton, Shelbyville, KY (US)

(73) Assignee: Owens Corning Intellectual Capital, LLC, Toledo, OH (US)

(21) Appl. No.: 13/855,956

(22) Filed: Apr. 3, 2013

Related U.S. Application Data
(63) Continuation of application No. 12/002,649, filed on Dec. 18, 2007.
(60) Provisional application No. 60/877,481, filed on Dec. 27, 2006.

(51) Int. Cl. F16L 59/02; B29C 65/72

(52) U.S. Cl. CPC F16L 59/026; B29C 65/72
USPC 442/342; 156/91; 156/296

(57) ABSTRACT

An insulation blanket includes a blend of a first component and a second component. The first component is a first fiber material selected from a group consisting of glass fibers, mineral fibers, basalt fibers, natural fibers and mixtures thereof. The second component is made of a second material selected from a group consisting of thermoplastic copolymer bi-component fibers, monofilament fibers, a thermal setting resin and mixtures thereof.

### TECHNICAL FIELD AND INDUSTRIAL APPLICABILITY OF THE INVENTION

The present invention relates generally to the insulation field and, more particularly, to insulation blankets made from a loose filled blend of materials.

### BACKGROUND OF THE INVENTION

Non-woven fibrous insulation blankets made from a mixture of reinforcing fibers and a binder such as binding fibers or powder or liquid resins have long been known in the art. Examples of such blankets are disclosed in, for example, U.S. Pat. Nos. 4,946,738, 4,889,764, 4,888,235 and 4,751,134 all to Chenoweth et al, U.S. Pat. No. 4,418,031 to Doerer et al, U.S. Pat. No. 5,983,586 to Berden, II et al. and U.S. Pat. No. 6,669,265 to Tilton et al. The use of glass fiber with average diameters of less than 5 microns in such blankets in order to provide desired thermal conductivity properties has been recognized in the prior art as exemplified by U.S. Pat. No. 4,759,785 to Barthe et al. and U.S. Pat. No. 5,674,307 to Huey et al.

The present invention relates to blended blankets that are both inexpensive to produce and provide still further enhanced and desirable properties over those available from blankets found in the prior art.

### SUMMARY OF THE INVENTION

In accordance with the purposes of the present invention as described herein, an improved non-woven insulation blanket is provided. The insulation blanket comprises a blend of a first component and a second component. The first component is a first fiber material selected from a group consisting of glass fibers, mineral fibers, basalt fibers, natural fibers and mixtures thereof having an average fiber diameter of between about 2 to about 20 microns. The second component is made from a second material selected from a group consisting of (a) thermoplastic copolymer bi-component fibers composed of polyester, polyolefin, nylon, rayon and mixtures thereof, (b) monofilament fibers composed of polyester, polyolefin and nylon wherein those fibers under (a) and (b) have an average fiber diameter of between about 10 to about 30 microns, (c) a thermal setting resin composed of polyvinyl acetate resin, acrylic resin, phenolic resin and mixtures thereof and (d) mixtures of (a), (b) and (c). Further, the blend includes between about 5 to about 95 weight percent of the first component and between about 5 to about 95 weight percent of the second component. More typically, the blend includes between about 30 to about 70 weight percent of the first component and between about 30 to about 70 weight percent of the second component. The fibers of the first component may have an average length of between about 6.35 to about 304.8 mm while fibers of the second component may have an average length of between about 12.7 to about 152.4 mm.

In one possible embodiment the first component and the second component that are blended in the insulation blanket are heat bonded together with a first polymer of the thermoplastic copolymer bi-component fibers being melted and a second polymer of the thermoplastic copolymer bi-component fiber maintaining fiber integrity. In yet another embodiment, the first and second components are mechanically bonded by needling.

More specifically describing the invention, the glass fibers utilized for the first component may be selected from a group consisting of textiles fibers including wet use chopped strand and dry use chopped strand, rotary fibers, flame attenuated fibers, bi-component glass fibers and mixtures thereof. The fibers may be straight or crimped in shape.

Still further, the thermoplastic copolymer bi-component fibers may be selected from a group consisting of core-sheath configuration, side-side configuration and mixtures thereof. The materials used for the second component fibers may be amorphous, crystalline or mixtures thereof. Typically, the insulation blanket of the present invention has a density of between about 0.4 and about 10.0 lbs/ft³.

In yet another possible embodiment of the present invention, the first fiber material includes a first group of fibers having an average fiber length of between about 6.35 and about 50.0 mm and an average fiber diameter of between about 2.0 and about 5.0 microns and a second group of fibers having an average fiber length of between about 25.4 and about 304.8 mm and an average fiber diameter of between about 6.0 and about 20.0 microns. Typically, the blend includes between about 5 and about 70 weight percent of the first group of fibers and between 5 and about 70 weight percent of the second group of fibers. More typically, the blend includes between about 20 and about 60 weight percent of the first group of fibers and between about 20 and about 60 weight percent of the second group of fibers.

In accordance with yet another aspect of the present invention an electric appliance is provided comprising a housing, a heating element and an insulation blanket of the type described above carried on at least a portion of the housing.

In accordance with yet another aspect of the present invention a dishwasher is provided comprising a housing and an insulation blanket of the type described above carried on at least a portion of the housing.

In accordance with still another aspect of the present invention a method is provided for insulating an electric appliance. The method comprises providing an insulation blanket of the type described above.

In the following description there is shown and described preferred embodiments of the invention, simply by way of illustration of several of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification, illustrates several aspects of the present invention and together with the description serves to explain certain principles of the invention. In the drawing:

FIG. 1 is a partially schematical, perspective view of a dishwasher equipped with an insulation blanket of the present invention.

Reference will now be made in detail to the present preferred embodiments of the invention, examples of which are illustrated in the accompanying drawing.

### DETAILED DESCRIPTION AND PREFERRED EMBODIMENTS OF THE INVENTION

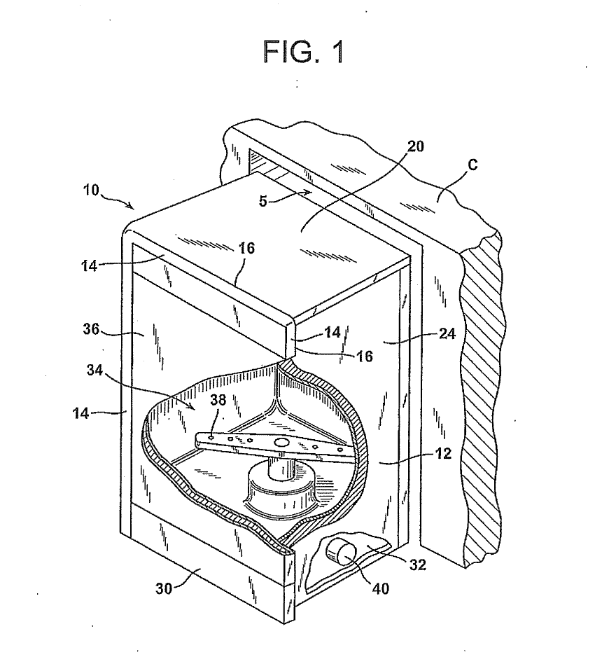

An insulation blanket 10 is illustrated in FIG. 1. The insulation blanket 10 comprises a blend of a first component and a second component. The first component is a first fiber material selected from a group consisting of glass fibers, mineral fibers, basalt fibers, natural fibers and mixtures thereof having an average fiber diameter of between about 2 and about 20 microns. Natural fibers useful in the present invention include hemp, kenaf, jutte, cotton and the like. Glass fibers useful in the present invention include textile glass fibers including wet use chopped strand, dry use chopped strand, E-glass, rotary glass fibers, flame attenuated glass fiber and bi-component glass fibers such as sold under the Miraflex trademark by Owens-Corning Fiberglas Technology, Inc. of Summitt, Ill. Continuous glass fibers may be used and are typically chopped to a length of between about 12.7 and 152.4 mm. Rotary and flame attenuated glass fibers may be any length but are generally 25.4 to 304.8 mm in length and could be pre-chopped to a length of 6.35 to about 76.2 mm.

The fibers may be straight or irregular shaped such as crimped. Where glass fibers are used, they are typically of the loose fill, wet use chopped strand or textile variety although other forms could be used. The glass fibers may be E-glass or another type as desired. The fibers may be treated with known lubricants and/or known anti-stat agents to aid in handling. Lubricants useful in the present invention include but are not limited to silicones, silanes and mineral oil. Anti-stats useful in the present invention include but are not limited to various quaternary ammonium compounds.

The second component of the insulation blanket may be made from a second material selected from a group consisting of (a) thermoplastic copolymer bi-component fibers composed of polyester, polyolefin, nylon, rayon and mixtures thereof, (b) monofilament fibers composed of polyester, polyolefin and nylon wherein said fibers under (a) and (b) have a diameter of between about 10 to about 30 microns, (c) a thermosetting resin composed of polyvinyl acetate resin, acrylic resin, phenolic resin and mixtures thereof and (d) mixtures of (a), (b) and (c). While the fibers in (a) and (b) may be substantially any length, they are generally between about 12.7 to about 152.4 mm for best results. Substantially any configuration of bi-component fibers may be used including but not limited to core-sheath configuration, side-side configuration and mixtures thereof. Further, the fibers used for the second component may be amorphous or crystalline in nature or mixtures thereof.

The insulation blanket 10 is a blend of between about 5 to about 95 weight percent of the first component and between about 5 to about 95 weight percent of the second component. More typically, the blanket 10 is a blend of between about 30 to about 70 weight percent of the first component and between about 30 to about 70 weight percent of the second component. In one possible embodiment the first component and second component of the blanket are heat bonded together. Typically, where the second component includes fibers such, as thermoplastic copolymer bi-component fibers, those fibers are not melted out during the heat bonding process. Thus, for example, heat bonding may take place by melting the first polymer of the bi-component fibers with the lower melting point while not melting and maintaining the fiber integrity of the second polymer of the bi-component fiber having the higher melting point. Alternatively, the first component and second component of the blanket may be mechanically bonded together by needling. In yet another alternative both a heat bonding process and a needling process may be used to bind the components together and provide a blanket with a desired density. Typically the blanket 10 has a density of between about 0.4 and about 10.0 lbs/ft³.

In still another embodiment, the first fiber material used in the blanket 10 includes a first group of fibers having an average fiber length of between about 6.35 and about 50.0 mm and an average fiber diameter of between about 2.0 and about 5.0 microns and a second group of fibers having an average fiber length of between about 25.4 and about 304.8 mm and an average fiber diameter of between about 6.0 and about 20.0 microns. Where two groups of fibers are utilized for the first fiber material, the insulation blanket 10 includes between about 5 and about 70 weight percent of the first group of fibers and between about 5 and about 70 weight percent of the second group of fibers. More typically, the insulation blanket includes between about 20 and about 60 weight percent of the first group of fibers and between about 20 and about 60 weight percent of the second group of fibers. The amount of each group of fibers included in the blanket may be varied to tune the thermal insulative, acoustic and structural properties to meet the needs of any particular application.

By using lower fiber diameter loose filled glass fibers in the blanket 10 of the present invention it is possible to improve thermal and acoustical performance and, simultaneously, advantageously provide an UL 94 V-O fire rating. The glass fibers can be produced in line to help lower the cost of manufacture of the blanket 10. Further, the blending of the glass fibers with polymer fibers improves the “feel” of the blanket 10 compared to a 100% glass fiber blanket making it more acceptable to handle by assembly workers and installers. For certain applications the blending of the glass fibers and polymer fibers of the first and second components may be completed by needling instead of heat bonding. This can lower the cost of the blanket 10. Further, the use of the polymer fibers allows the subsequent molding of the blanket to a desired shape without adding additional binder materials when desired. In addition, a blanket 10 including rotary glass fibers of fine diameter for enhanced, thermal properties and longer glass fibers for structural properties bond together by needling allows efficient, in-line production of a lower cost, high temperature insulation product.

If desired, the blanket 10 may be subjected to a surface treatment of a type as described in U.S. Pat. No. 6,669,265 to Tilton et al or U.S. Pat. No. 7,128,561 to Rockwell et al. Such a treatment serves to densify the surface, locking in the fibers. Thus, the surface is smoother and more resistant to fraying, making the blanket 10 easier to handle during installation.

It should be appreciated that the insulation blanket 10 is particularly useful in insulating various components including but not limited to electric and kitchen appliances such as dishwashers, clothes washers, clothes dryers, water heaters, coffee makers, toasters, vacuum cleaners and the like. As illustrated in FIG. 1 the insulation blanket 10 may be wrapped around the housing 32 of a dishwasher 30 adapted for mounting in space S under a counter C. As illustrated the dishwasher 30 includes a housing 32 including both a washing chamber 34 and a door 36 for gaining access to the washing chamber. A washing nozzle or cleaning element 38 in the washing chamber 34 directs a fluid stream against dishes held in the washing chamber. A circulation pump 40 circulates that fluid under pressure through the washing nozzle 38.

Reference is now made to Table 1 in order to illustrate the enhanced acoustical insulating properties of the blanket 10 of the present invention compared to a typical cotton shoddy and a typical 100% polyester insulator of the prior art.

| | Absorption Coefficient | | |
|---|---|---|---|
| | 3/4″ 3.2 lb/cu. ft. | 3/4″ 3.2 lb/cu. ft. | 3/4″ 3.2 lb/cu. ft. |
| frequency | Typical | Typical Polyester | Glass-PET Blend |
| (Hz) | Cotton Shoddy | Fiber Product | (per this invention) |
| 100 | 0.01 | 0.00 | 0.00 |
| 125 | 0.02 | 0.00 | 0.01 |
| 160 | 0.03 | 0.00 | 0.01 |
| 200 | 0.04 | 0.01 | 0.03 |
| 250 | 0.04 | 0.02 | 0.05 |
| 315 | 0.06 | 0.04 | 0.08 |
| 400 | 0.09 | 0.07 | 0.14 |
| 500 | 0.12 | 0.09 | 0.19 |
| 630 | 0.16 | 0.15 | 0.28 |
| 800 | 0.21 | 0.23 | 0.40 |
| 1000 | 0.27 | 0.33 | 0.52 |
| 1250 | 0.36 | 0.44 | 0.64 |
| 1600 | 0.48 | 0.56 | 0.76 |
| 2000 | 0.57 | 0.68 | 0.84 |
| 2500 | 0.70 | 0.78 | 0.90 |
| 3150 | 0.83 | 0.87 | 0.93 |
| 4000 | 0.93 | 0.93 | 0.95 |
| 5000 | 0.98 | 0.95 | 0.95 |
| 6300 | 0.98 | 0.92 | 0.95 |

The table lists the absorption coefficients for the various frequencies listed. Frequency is given in Hertz (Hz) and the absorption coefficients represent how effective the materials are at absorbing sound for the given frequencies. The absorption coefficient values range from 0 (no sound absorption) to 1.0 where 100% of the sound is absorbed. In reality it is not possible for a material to have an absorption coefficient value greater than 1.0 although sound measurements can sometimes register values greater thin 1.0 due to material edge effects.

As should be appreciated, the blanket 10 of the present invention provides superior acoustic performance to the prior art cotton shoddy and 100% polyester fiber products of identical densities and thicknesses at all frequencies from 250 Hz to 4,000 Hz. The most significant improvement is provided in the important range from between 800 to 1600 Hz. This is the range of the human voice and highest sensitivity of human hearing.

The foregoing description of preferred embodiments of the invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one or ordinary skill in the art to utilize the invention in various embodiments and with various modifications as is suited a particular use contemplated. All such modifications and variations are within the scope of the invention as determined by the appended claims when interpreted in accordance with the breadth to which they are fairly, legally and equitably entitled.

1-16. (canceled)

17. A method of making an insulation blanket, comprising the steps of:
blending glass fibers and thermoplastic copolymer bi-component fibers, wherein the glass fibers have an average fiber diameter of between about 2 to about 20 microns and the thermoplastic copolymer bi-component fibers have an average fiber diameter of between about 10 to about 30 microns, and wherein the thermoplastic copolymer bi-component fibers comprise a first layer made from a first polymer and a second layer made from a second polymer, the first polymer having a lower melting point than the second polymer; and
heat bonding the glass fibers and the thermoplastic copolymer bi-component fibers together with the first polymer of the thermoplastic copolymer bi-component fibers being melted and the second polymer of the thermoplastic copolymer bi-component fibers maintaining fiber integrity to form an insulation blanket without adding binder in addition to the first polymer of the thermoplastic copolymer bi-component fibers, and wherein the glass fibers are produced inline with the heat bonding and forming of the insulation blanket.

18. The method of claim 17, wherein the glass fibers have an average fiber length of between about 6.35 to about 304.8 mm and the thermoplastic copolymer bi-component fibers have an average fiber length of between about 12.7 to about 152.4 mm.

19. The method of claim 17 further comprising mechanically bonding the glass fibers and the thermoplastic copolymer bi-component fibers together.

20. The method of claim 19, wherein the glass fibers and the thermoplastic copolymer bi-component fibers are mechanically bonded by needling.

21. The method of claim 17 further comprising molding the insulation blanket into a desired shape.

22. The method of claim 17, wherein the glass fibers comprise any one or combination of rotary fibers and flame attenuated fibers.

23. The method of claim 17, wherein the glass fibers are straight or crimped in shape.

24. The method of claim 17, wherein the thermoplastic copolymer bi-component fibers comprise any one or combination of a core-sheath configuration and a side-side configuration.

25. The method of claim 17, wherein the thermoplastic copolymer bi-component fibers comprise any one or combination of amorphous fibers and crystalline fibers.

26. The method of claim 17, wherein the insulation blanket has a density of between about 0.4 and about 10.0 lbs/ft³.

27. The method of claim 17, wherein the glass fibers include a first group of fibers having an average fiber length of between about 6.35 and about 50.0 mm and an average fiber diameter of between about 2.0 and about 5.0 microns and a second group of fibers having an average fiber length of between about 25.4 and about 304.8 mm and an average fiber diameter of between about 6.0 and about 20.0 microns.

28. The method of claim 27, wherein the insulation blanket includes between about 5 and about 70 weight percent of the first group of fibers and between about 5 and about 70 weight percent of the second group of fibers.

29. The method of claim 27, wherein the insulation blanket includes between about 20 and about 60 weight percent of the first group of fibers and between about 20 and about 60 weight percent of the second group of fibers.

30. The method of claim 17, wherein the insulation blanket includes between about 30 to about 70 weight percent of the glass fibers and between about 30 to about 70 weight percent of the thermoplastic copolymer bi-component fibers.

31. The method of claim 17, wherein the insulation blanket comprises monofilament fibers mixed with the thermoplastic copolymer bi-component fibers, the monofilament fibers comprising any one or any combination of any two or more of polyester fibers, polyolefin fibers, and nylon fibers having an average fiber diameter of between about 10 to about 30 microns.

32. The method of claim 17, wherein the glass fibers are mixed with any one or more of mineral fibers, basalt fibers, and natural fibers and the thermoplastic copolymer bi-component fibers comprise any one or any combination of any two or more of polyester fibers, polyolefin fibers, nylon fibers, and rayon fibers.

33. The method of claim 17, wherein the glass fibers have an average fiber length of between about 6.35 and about 50.0 mm and an average fiber diameter of between about 2.0 and about 5.0 microns, and wherein the thermoplastic copolymer bi-component fibers have an average fiber length of between about 25.4 and about 304.8 mm and an average fiber diameter of between about 6.0 and about 20.0 microns.

34. A method of making an insulation blanket, comprising the steps of:
blending mineral fibers and thermoplastic copolymer bi-component fibers, wherein the mineral fibers have an average fiber diameter of between about 2 to about 20 microns and the thermoplastic copolymer bi-component fibers have an average fiber diameter of between about 10 to about 30 microns, and wherein the thermoplastic copolymer bi-component fibers comprise a first layer made from a first polymer and a second layer made from a second polymer, the first polymer having a lower melting point than the second polymer; and
heat bonding the mineral fibers and the thermoplastic copolymer bi-component fibers together with the first polymer of the thermoplastic copolymer bi-component fibers being melted and the second polymer of the thermoplastic copolymer bi-component fibers maintaining fiber integrity to form an insulation blanket without adding binder in addition to the first polymer of the thermoplastic copolymer bi-component fibers, and wherein the mineral fibers are produced inline with the heat bonding and forming of the insulation blanket.

35. The method of claim 34, wherein the thermoplastic copolymer bi-component fibers comprise any one or any combination of any two or more of polyester fibers, polyolefin fibers, nylon fibers, and rayon fibers.

36. The method of claim 34, wherein the mineral fibers comprise a first group of fibers and a second group of fibers, and wherein the first group of mineral fibers has an average fiber length of between about 6.35 and about 50.0 mm and an average fiber diameter of between about 2.0 and about 5.0 microns, and wherein the second group of mineral fibers has an average fiber length of between about 25.4 and about 304.8 mm and an average fiber diameter of between about 6.0 and about 20.0 microns.

37. The method of claim 34, wherein the insulation blanket includes between about 30 to about 70 weight percent of the mineral fibers and between about 30 to about 70 weight percent of the thermoplastic copolymer bi-component fibers.

38. An insulation blanket, comprising:
a blend of glass fibers and the thermoplastic copolymer bi-component fibers, wherein the glass fibers have an average fiber diameter of between about 2 and about 20 microns and the thermoplastic copolymer bi-component fibers have an average fiber diameter of between about 10 and about 30 microns, wherein the thermoplastic copolymer bi-component fibers comprise a first polymer and a second polymer, the first polymer having a lower melting point than the second polymer;
wherein the glass fibers and the thermoplastic copolymer bi-component fibers are heat bonded together with the first polymer of the thermoplastic copolymer bi-component fibers being melted and the second polymer of the thermoplastic copolymer bi-component fibers maintaining fiber integrity to form the insulation blanket without adding binder in addition to the first polymer of the thermoplastic copolymer bi-component fibers; and
wherein the glass fibers are produced inline with said heat bonding and said forming of said insulation blanket.
